(19) United States
(12) Patent Application Publication
(10) Pub. No.: US 2009/0002602 A1
(43) Pub. Date: Jan. 1, 2009

(54) Liquid crystal display with micro-structures and liquid crystal display driving method

(75) Inventor: Yu-Ju Hsu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/215,440

(22) Filed: Jun. 27, 2008

(30) Foreign Application Priority Data
Jun. 29, 2007 (CN) 200710076257.5

(51) Int. Cl. G02F 1/13357; G09G 3/36

(52) U.S. Cl. 349/65; 345/102

(57) ABSTRACT

An exemplary liquid crystal display (200) includes at least two light guide plates (211, 212) laminated to each other. Each light guide plate includes a light emitting surface and a bottom surface opposite to the light emitting surface, each light guide plate is divided into at least three parts, one light guide plate includes micro-structures on the light emitting surface and the bottom surface in any part, and the parts with the micro-structures of the same light guide plate are separated from each other. A related method for driving the liquid crystal display is also provided.

### FIELD OF THE INVENTION

The present invention relates to liquid crystal displays and driving methods thereof, and particularly to a liquid crystal display with micro-structures and a driving method for the same.

### GENERAL BACKGROUND

Because liquid crystal displays have the advantages of portability, low power consumption, and low radiation, they have been widely used in various portable information products such as notebooks, personal digital assistants, video cameras, and the like. Furthermore, liquid crystal displays are considered by many to have the potential to completely replace cathode ray tube monitors and televisions.

FIG. 9 is a schematic, pre-assembled view of a conventional liquid crystal display. The liquid crystal display 1 includes a liquid crystal panel 10 and a backlight module 12.

FIG. 10 is a block diagram illustrating circuitry of the liquid crystal display 1. The liquid crystal panel 10 includes a gate driving circuit 14, a data driving circuit 16, a timing controller 18, a plurality of parallel scan lines 101, a plurality of parallel data lines 103, a plurality of pixel electrodes 105, a plurality of thin film transistors 107, and a plurality of common electrodes 109.

The timing controller 18 is electrically coupled to the gate driving circuit 14 and the data driving circuit 16, respectively. The gate driving circuit 14 drives the scan lines 101, and the data driving circuit 16 drives the data lines 103. The scan lines 101 are orthogonal to and isolated from the data lines 103. The scan lines 101 and data lines 103 thereby cooperatively define a plurality of pixel regions 108 arranged in a regular array. In each pixel region 108, a pixel electrode 105 and a corresponding common electrode 109 are disposed generally opposite to each other. Each thin film transistor 107 is positioned near a crossing of a corresponding scan line 101 and a corresponding data line 103. A gate electrode of the thin film transistor 107 is electrically coupled to the scan line 101, and a source electrode of the thin film transistor 107 is electrically coupled to the data line 103. Further, a drain electrode of the thin film transistor 107 is electrically coupled to the corresponding pixel electrode 105.

The backlight module 12 comprises an inverter 15 and a plurality of lamps 13. In operation, the inverter 15 provides voltage signals to drive the lamps 13 to emit light beams, thereby illuminating the liquid crystal panel 10.

FIG. 11 shows waveform diagrams of scanning signals transmitted in the liquid crystal panel 10. Under control of the timing controller 18, the gate driving circuit 14 respectively provides a plurality of scanning signals X1˜Xn to the plurality of scan lines G1˜Gn during a frame time period T. Taking a scan line G2 as an example, when the scanning signal X2 is transmitted to the scan line G2, the thin film transistors 107 electrically coupled to the scan line G2 are turned on.

Simultaneously, under the control of the timing controller 18, the data driving circuit 16 provides a plurality of data signals to the plurality of data lines 103 respectively, wherein the data signals are high-voltage signals. During the time the scanning signals X2 are transmitted to the scan line G2, the data signals are transmitted to the pixel electrodes 105 via the source electrode and the drain electrode of each of the thin film transistors 107 electrically coupled to the scan line G2. Pixel regions 108 coupled to the scan line G2 display an image accordingly, and maintain the data signals for a total period of time equal to one frame time period T. That is, before subsequent scanning signals are provided to the scan line G2, the pixel regions 108 coupled to the scan line G2 maintain the data signals.

In the next frame time period (not labeled), the scanning signal X2 is provided to the scan line G2 to turn on the thin film transistors 107 electrically coupled to the scan line G2, and simultaneously subsequent data signals are provided to the pixel electrodes 105 via the source electrode and the drain electrode of each of the thin film transistors 107 electrically coupled to the scan line G2. Thereby, the pixel regions 108 coupled to the scan line G2 display a subsequent image, and maintain subsequent data signals for a total period of time equal to one frame time period T.

However, when the pixel regions 108 of the liquid crystal panel 10 display the same image for a sustained period, image-sticking may be generated on the liquid crystal panel 10. When the liquid crystal panel 10 switches to display a subsequent image, the data signals maintained in the pixel regions 108 cannot be rapidly released, and offset voltages are liable to be generated between the pixel electrodes 105 and the common electrodes 109 of the pixel regions 108. The offset voltages may affect the display quality of the liquid crystal panel 10 during the subsequent time period, such that the liquid crystal panel 10 experiences image-sticking.

What is needed, therefore, is a liquid crystal display and a driving method for the same that can overcome the limitations described.

### SUMMARY

A liquid crystal display comprises at least three light sources and at least two light guide plates laminated to each other. Each light guide plate includes a top light emitting surface and a bottom surface, and is divided into at least three parts. Only one light guide plate comprises micro-structures on the light emitting surface and the bottom surface in any part, and the parts with micro-structures of the same light guide plate are separated from each other. Each light source is disposed adjacent to one of the light incident surfaces of the at least two light guide plates.

Other novel features and advantages will become more apparent from the following detailed description when taken in conjunction with the accompanying drawings.

### BRIEF DESCRIPTION OF THE DRAWINGS

FIG. 1 is a side view of a liquid crystal display according to a first embodiment of the present invention, the liquid crystal display including a backlight module.

FIG. 2 is an exploded, isometric view of the backlight module of FIG. 1, comprising two light guide plates with V-cut groove structures, and first, second, third, and fourth light sources.

FIG. 3 is a coordinate diagram of pitch between V-cut groove structures and the total number of the V-cut groove structures, in respect of the light guide plates of the liquid crystal display of FIG. 1.

FIG. 4 is an optical path diagram of the backlight module of FIG. 1 when the second light source is turned on.

FIG. 5 is an optical path diagram of the backlight module of FIG. 1 when the fourth light source is turned on.

FIG. 6 is a block diagram illustrating abbreviated circuitry of the liquid crystal display of FIG. 1.

FIG. 7 is a waveform diagram showing driving signals generated by the liquid crystal display of FIG. 1.

FIG. 8 is a side view of a liquid crystal display according to a second embodiment of the present invention.

FIG. 9 is a schematic, pre-assembled view of a conventional liquid crystal display.

FIG. 10 is a block diagram illustrating abbreviated circuitry of the liquid crystal display of FIG. 9.

FIG. 11 is a waveform diagram showing scanning signals transmitted in the liquid crystal display of FIG. 9.

### DETAILED DESCRIPTION OF PREFERRED EMBODIMENTS

Reference will now be made to the drawings to describe preferred and exemplary embodiments in detail.

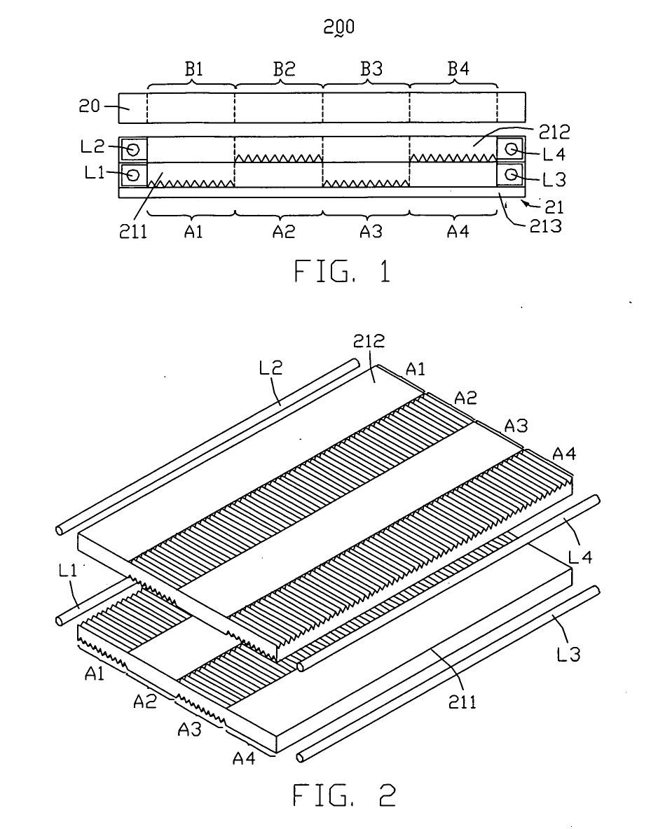

FIG. 1 is a side view of a liquid crystal display according to a first embodiment of the present invention. The liquid crystal display 200 includes a backlight module 21 and a liquid crystal panel 20 disposed thereon. The backlight module 21 comprises a first light guide plate 211, a second light guide plate 212, a reflector 213, a first light source L1, a second light source L2, a third light source L3, and a fourth light source L4. The first light guide plate 211 is disposed between the liquid crystal panel 20 and the reflector 213, and the second light guide plate 212 is disposed between the liquid crystal panel 20 and the first light guide plate 211. The first and second light guide plates 211, 212 are rectangular. The first and second light guide plates 211, 212 are made of polymethyl methacrylate. Refractive indices of the first and second light guide plates 211, 212 are both 1.49. Each of light guide plate 211, 212 includes a first light incident surface (not labeled), a second light incident surface (not labeled), a top light emitting surface (not labeled), and a bottom surface (not labeled). The first and second light incident surfaces are at opposite sides of the light plate 211, 212. The first light incident surface is perpendicularly connected with both the light emitting surface and the bottom surface. Each of the light guide plates 211, 212 is divided into a first part A1, a second part A2, a third part A3, and a fourth part A4, all having the same area. A display area of the liquid crystal panel 20 is divided into a first part B1 corresponding to the first part A1, a second part B2 corresponding to the second part A2, a third part B3 corresponding to the third part A3, and a fourth part B4 corresponding to the fourth part A4.

The first light source L1, the second light source L2, the third light source L3, and the fourth light source L4 may be cold cathode fluorescent lamps. The first light source L1 is disposed adjacent to the first light incident surface of the first light guide plate 211. The second light source L2 is disposed adjacent to the first light incident surface of the second light guide plate 212. The third light source L3 is disposed adjacent to the second light incident surface of the first light guide plate 211. The fourth light source L4 is disposed adjacent to the second light incident surface of the second light guide plate 212.

FIG. 2 is an exploded, isometric view of the backlight module 21. The light emitting surface of the first part A1 of the first light guide plate 211, the light emitting surface of the third part A3 of the first light guide plate 211, the light emitting surface of the second part A2 of the second light guide plate 212, and the light emitting surface of the fourth part A4 of the second light guide plate 212 all comprise micro-structures, such as V-cut groove structures. In the illustrated embodiment, pitches of the V-cut groove structures are constant, and extension axes of the V-cut groove structures are all perpendicular to the four light sources L1, L2, L3, L4.

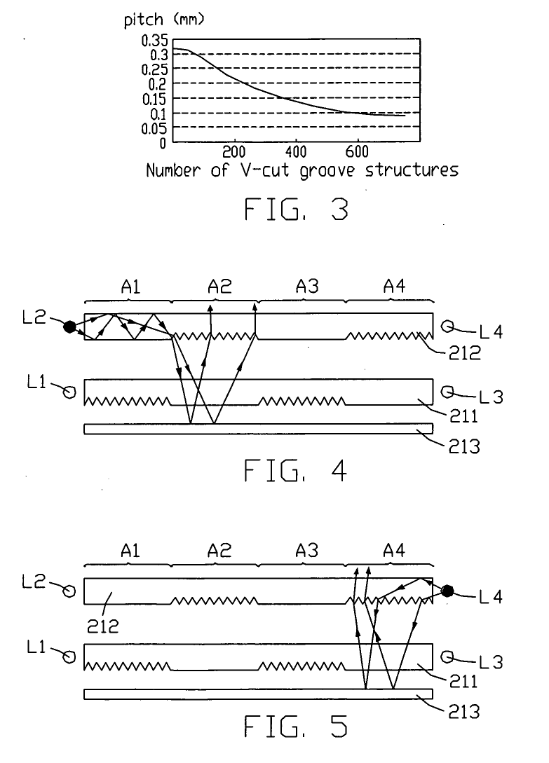

The bottom surface of the first part A1 of the first light guide plate 211, the bottom surface of the third part A3 of the first light guide plate 211, the bottom surface of the second part A2 of the second light guide plate 212, and the bottom surface of the fourth part A4 of the second light guide plate 212 all comprise micro-structures, such as V-cut groove structures. Pitches of the V-cut groove structures are variable, as shown in FIG. 3. Extension axes of the V-cut groove structures are all parallel to the four light sources L1, L2, L3, L4.

FIG. 4 is an optical path diagram of the backlight module when the second light source L2 is turned on, and FIG. 5 is an optical path diagram of the backlight module when the fourth light source L4 is turned on. When the second light source L2 is turned on, light beams emitted from the second light source L2 enter the second light guide plate 212, with most being totally reflected by the light emitting surface and the bottom surface of the first part A1 of the second light guide plate 212 and then entering the second part A2 of the second light guide plate 212. A few of the light beams exit from the light emitting surface of the first part A1 of the second light guide plate 212.

A first portion of the light beams entering into the second part A2 of the second light guide plate 212 is directly emitted from the light emitting surface of the second light guide plate 212 and enters the liquid crystal panel 20. A second portion of the light beams entering the second part A2 of the second light guide plate 212 is refracted by the V-cut groove structures of the bottom surface of the second part A2 of the second light guide plate 212, then passes through the first light guide plate 211 and is reflected by the reflector 213, finally passing through the first light guide plate 211, the second light guide plate 212 and entering the liquid crystal panel 20. A third portion of the light beams entering the second part A2 of the second light guide plate 212 enters the third part A3 and the fourth part A4 of the second light guide plate 212. The third portion of the light beams entering the second part A2 of the second light guide plate 212 is much less than the first portion of the light beams entering the second part A2 of the second light guide plate 212 or the second portion of the light beams entering the second part A2 of the second light guide plate 212.

Thus, when the second light source L2 is turned on, most of the light beams emitted from the second light source L2 exit from the light emitting surface of the second part A2 of the second light guide plate 212, and a minimum of the light beams emitted from the second light source L2 exit from the light emitting surface of the first part A1 of the second light guide plate 212, the light emitting surface of the third part A3 of the second light guide plate 212, and the light emitting surface of the fourth part A4 of the second light guide plate 212. Accordingly, the second parts A2 of the first light guide plate 211 and the second light guide plate 212 are defined as strong light parts, and the first parts A1 of the first light guide plate 211 and the second light guide plate 212, the third parts A3 of the first light guide plate 211 and the second light guide plate 212, and the fourth parts A4 of the first light guide plate 211 and the second light guide plate 212 are defined as weak light parts. The second part B2 of the liquid crystal panel 20 is correspondingly defined as a strong light part, and the first part B1 of the liquid crystal panel 20, the third part B3 of the liquid crystal panel 20, and the fourth part B4 of the liquid crystal panel 20 are correspondingly defined as weak light parts.

When the fourth light source L4 is turned on, light beams emitted from the fourth light source L4 enter the second light guide plate 212. A first portion of the light beams directly exit from the light emitting surface of the fourth part A4 of the second light guide plate 212 and enter the liquid crystal panel 20. A second portion of the light beams is refracted by the V-cut groove structures of the bottom surface of the fourth part A4 of the second light guide plate 212, then passes through the first light guide plate 211 and is reflected by the reflector 213, finally passing through the first light guide plate 211, the second light guide plate 212 and entering the liquid crystal panel 20. A third portion of the light beams enters the third part A3, the second part A2, and the first part A1 of the second light guide plate 212. The third portion of the light beams is much less than the first portion of the light beams or the second portion of the light beams.

Further, when the fourth light source L4 is turned on, most of the light beams emitted from the fourth light source L4 exit from the light emitting surface of the fourth part A4 of the second light guide plate 212, and a minimum of the light beams emitted from the fourth light source L4 exit from the light emitting surface of the first part A1 of the second light guide plate 212, the light emitting surface of the second part A2 of the second light guide plate 212, and the light emitting surface of the third part A3 of the second light guide plate 212. Accordingly, the fourth parts A4 of the first light guide plate 211 and the second light guide plate 212 are defined as strong light parts, and the first parts A1 of the first light guide plate 211 and the second light guide plate 212, the second parts A2 of the first light guide plate 211 and the second light guide plate 212, and the third parts A3 of the first light guide plate 211 and the second light guide plate 212 are defined as weak light parts. The fourth part B4 of the liquid crystal panel 20 is correspondingly defined as a strong light part, and the first part B1 of the liquid crystal panel 20, the second part B2 of the liquid crystal panel 20, and the third part B3 of the liquid crystal panel 20 are correspondingly defined as weak light parts.

As a result, when the first light source L1 is turned on, most of the light beams emitted from the first light source L1 exit from the light emitting surface of the first part A1 of the first light guide plate 211, and a minimum of the light beams emitted from the first light source L1 exit from the light emitting surface of the second part of the first light guide plate 211, the light emitting surface of the third part of the first light guide plate 211, and the light emitting surface of the fourth part of the first light guide plate 211. Thus, the first parts A1 of the first light guide plate 211 and the second light guide plate 212 are defined as strong light parts, and the second parts of the first light guide plate 211 and the second light guide plate 212, the third parts of the first light guide plate 211 and the second light guide plate 212, and the fourth parts of the first light guide plate 211 and the second light guide plate 212 are defined as weak light parts. The first part B1 of the liquid crystal panel 20 is correspondingly defined as a strong light part, and the second part B2 of the liquid crystal panel 20, the third part B3 of the liquid crystal panel 20, and the fourth part B4 of the liquid crystal panel 20 are correspondingly defined as weak light parts.

When the third light source L3 is turned on, most of the light beams emitted from the third light source L3 exit from the light emitting surface of the third part A3 of the first light guide plate 211, and a few of the light beams emitted from the third light source L3 exit from the light emitting surface of the first part of the first light guide plate 211, the light emitting surface of the second part of the first light guide plate 211, and the light emitting surface of the fourth part of the first light guide plate 211. Accordingly, the third parts of the first light guide plate 211 and the second light guide plate 212 are defined as strong light parts, and the first parts of the first light guide plate 211 and the second light guide plate 212, the second parts of the first light guide plate 211 and the second light guide plate 212, and the fourth parts of the first light guide plate 211 and the second light guide plate 212 are defined as weak light parts. The third part B3 of the liquid crystal panel 20 is correspondingly defined as a strong light part, and the first part B1 of the liquid crystal panel 20, the second part B2 of the liquid crystal panel 20, and the fourth part B4 of the liquid crystal panel 20 are correspondingly defined as weak light parts.

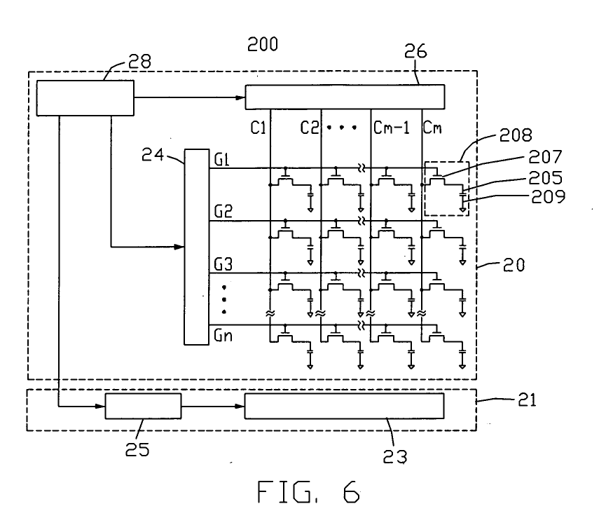

FIG. 6 is a block diagram illustrating abbreviated circuitry of the liquid crystal display 200. The liquid crystal panel 20 includes a scanning circuit 24, a data circuit 26, a timing controller 28, a plurality of scanning lines G1˜Gn, a plurality of data lines C1˜Cm, and a plurality of pixels 208 cooperatively defined by the crossing scanning lines G1˜Gn and data lines C1˜Cm. The plurality of scanning lines G1˜Gn are distributed across different parts of the liquid crystal panel 20. For example, when n is equal to 1024, the scanning lines G1˜G256 belong to the first part B1 of the liquid crystal panel 20, the scanning lines G257˜G512 belong to the second part B2 of the liquid crystal panel 20, the scanning lines G513˜G768 belong to the third part B3 of the liquid crystal panel 20, and the scanning lines G769˜G1024 belong to the fourth part B4 of the liquid crystal panel 20.

Each of the pixels 208 comprises a pixel electrode 205, a thin film transistor 207, and a common electrode 209 generally opposite the pixel electrode 205. The thin film transistor 207 is disposed near an intersection of a corresponding one of the scanning lines G1˜Gn and a corresponding one of the data lines C1˜Cm. A gate electrode of the thin film transistor 207 is electrically coupled to the corresponding one of the scanning lines G1˜Gn, and a source electrode of the thin film transistor 207 is electrically coupled to the corresponding one of the data lines C1˜Cm. Further, a drain electrode of the thin film transistor 207 is electrically coupled to the pixel electrode 205.

The backlight module 21 includes an inverter 25 and a light source module 23. The light source module 23 includes the first light source L1, the second light source L2, the third light source L3, and the fourth light source L4.

The timing controller 28 generates first control signals, second control signals, and third control signals. The scanning circuit 24 receives the first control signals and generates scanning signals to scan the plurality of scanning lines G1˜Gn. The data circuit 26 receives the second control signals and generates data signals to drive the plurality of data lines C1˜Cm. The inverter 25 receives the third control signals and generates backlight control signals to drive the light sources L1˜L4.

When the liquid crystal display 200 operates normally, the first to fourth light sources L1˜L4 are sequentially turned on or turned off. Only one of the light sources L1˜L4 is turned on at any one time, and others are turned off at such time.

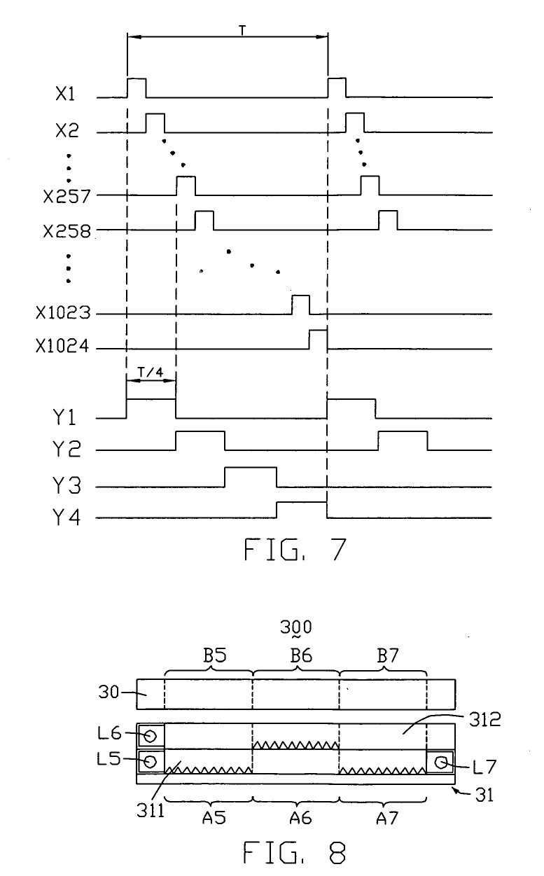

FIG. 7 is a waveform diagram showing driving signals generating by the driving circuit. In FIG. 7, X1˜X1024 represent the scanning signals of the scanning lines G1˜G1024 (n=1024) respectively, and Y1˜Y4 represent the backlight control signals of the light sources L1˜L4 respectively.

The timing controller 28 generates the first control signals, the second control signals, and the third control signals. The scanning circuit 24 receives the first control signals and generates the scanning signals X1˜X1024 to scan the plurality of scanning lines G1˜G1024. A time period in which the scanning line G1 is firstly scanned and secondly scanned is defined as a frame time period T. The data circuit 26 receives the second control signals and generates a plurality of data signals. The data signals are transmitted to the data lines C1˜Cm. The inverter 25 receives the third control signals and generates backlight control signals to turn on or turn off the light sources L1˜L4.

During a first time period T/4, the scanning lines G1˜G256 are scanned and the first light source L1 is turned on. Accordingly, the first parts A1 of the first light guide plate 211 and the second light guide plate 212 are strong light parts, and other parts A2, A3, A4 of the first light guide plate 211 and the second light guide plate 212 are weak light parts. The first part B1 of the liquid crystal panel 20 is a strong light part, and other parts B2, B3, B4 of the liquid crystal panel 20 are weak light parts correspondingly.

During a second time period T/4 (not labeled), the scanning lines G257˜G512 are scanned and the second light source L2 is turned on. Accordingly, the second parts A2 of the first light guide plate 211 and the second light guide plate 212 are strong light parts, and other parts A1, A3, A4 of the first light guide plate 211 and the second light guide plate 212 are weak light parts. The second part B2 of the liquid crystal panel 20 is a strong light part, and other parts B1, B3, B4 of the liquid crystal panel 20 are weak light parts correspondingly.

During a third time period T/4 (not labeled), the scanning lines G513˜G768 are scanned and the third light source L3 is turned on. Accordingly, the third parts A3 of the first light guide plate 211 and the second light guide plate 212 are strong light parts, and other parts A1, A2, A4 of the first light guide plate 211 and the second light guide plate 212 are weak light parts. The third part B3 of the liquid crystal panel 20 is a strong light part, and other parts B1, B2, B4 of the liquid crystal panel 20 are weak light parts correspondingly.

During a fourth time period T/4 (not labeled), the scanning lines G769˜G1024 are scanned and the fourth light source L4 is turned on. Accordingly, the fourth parts A4 of the first light guide plate 211 and the second light guide plate 212 are strong light parts, and other parts A1, A2, A3 of the first light guide plate 211 and the second light guide plate 212 are weak light parts. The fourth part B4 of the liquid crystal panel 20 is a strong light part, and other parts B1, B2, B3 of the liquid crystal panel 20 are weak light parts correspondingly.

After the 1024^{th} scanning line G1024 is scanned, a frame picture is formed on the liquid crystal panel 20. By repeating the process, continuous images can be viewed.

Because the strong light parts of the liquid crystal panel 20 change during the frame time period T, image-sticking can be minimized, with display quality of the liquid crystal panel 20 enhanced correspondingly.

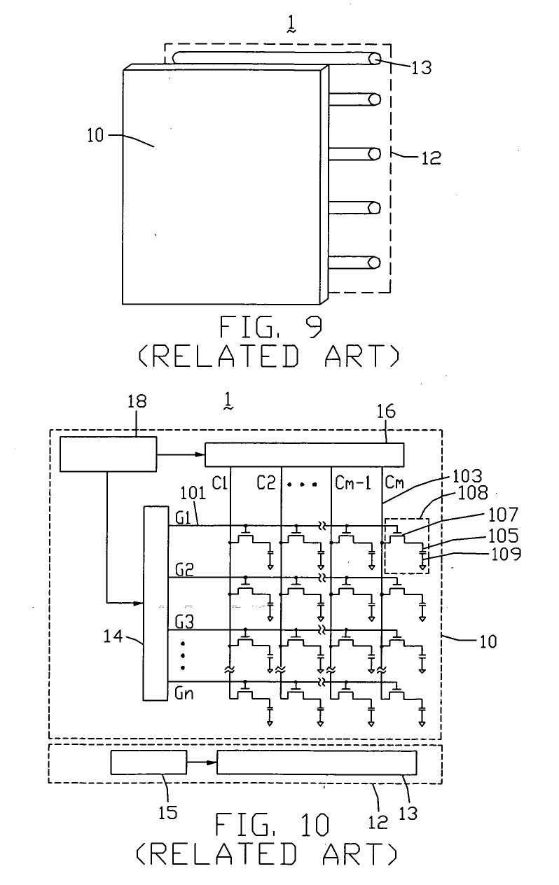

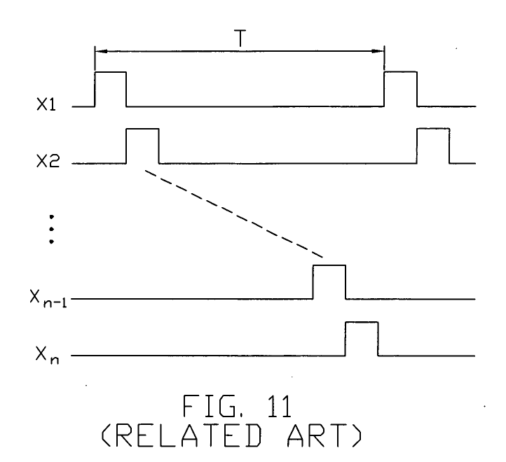

FIG. 8 is a side view of a liquid crystal display according to a second embodiment of the present invention. Characteristics of the liquid crystal display 300 differing from the liquid crystal display 200 are as follows:

The backlight module 31 includes a first light source L5, a second light source L6, and a third light source L7. The first light source L5 is disposed adjacent to the first light incident surface of the first light guide plate 311. The second light source L6 is disposed adjacent to one of the light incident surfaces of the second light guide plate 312. The third light source L7 is disposed adjacent to the second light incident surface of the first light guide plate 311. Each of the light guide plates 311, 312 is divided into a first part A5, a second part A6, and a third part A7. A display area of the liquid crystal panel 30 is divided into a first part B5 corresponding to the first part A5, a second part B6 corresponding to the second part A6, and a third part B7 corresponding to the third part A7.

The bottom surface of the first part A5 of the first light guide plate 311, the bottom surface of the third part A7 of the first light guide plate 311, and the bottom surface of the second part A6 of the second light guide plate 312 all comprise micro-structures, such as V-cut groove structures. Pitches of the V-cut groove structures are variable. Extension axes of the V-cut groove structures are all parallel to the three light sources L5, L6, L7.

The light emitting surface of the first part A5 of the first light guide plate 311, the light emitting surface of the third part A7 of the first light guide plate 311, and the light emitting surface of the second part A6 of the second light guide plate 312 all have micro-structures, such as V-cut groove structures. Pitches of the V-cut groove structures are constant, and extension directions of the V-cut groove structures are all perpendicular to the three light sources L5, L6, L7.

It can thus be concluded that when a number K (K is an integer, and ≧2) of the light sources is even, a number of light guide plates is K/2, the light guide plates and the liquid crystal panel are divided into K parts respectively, and a time period during which each light source is turned on is T/K. When K is an odd number, the number of light guide plates is (K+1)/2, the light guide plates and the liquid crystal panel are divided into K parts respectively, and the time during which each light source is turned on is T/K.

In alternative embodiments, the light sources can be linear-type light sources, such as a plurality of light emitting diodes connected in series.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display comprising:
at least three light sources; and
at least two light guide plates stacked one on the other;
wherein each light guide plate comprises a top light emitting surface, a bottom surface, and at least one light incident surface perpendicularly adjacent to both the light emitting surface and the bottom surface, each light guide plate is divided into at least three parts, for each part, one of the light guide plates only has micro-structures on the light emitting surface thereat and the bottom surface thereat, and for each light guide plate, the parts with micro-structures on the light emitting surface are separate from each other, and the parts with micro-structures on the bottom surface are separate from each other; and
each light source is disposed adjacent to one of the light incident surfaces of the at least two light guide plates.

2. The liquid crystal display of claim 1, wherein the micro-structures are V-cut groove structures.

3. The liquid crystal display of claim 2, wherein for each light guide plate, pitches of the V-cut groove structures on the light emitting surface are constant.

4. The liquid crystal display of claim 3, wherein for each light guide plate, a pitch of the V-cut groove structures on the bottom surface at one of the parts is different from the pitch of the V-cut groove structures at at least another one of the parts.

5. The liquid crystal display of claim 4, wherein the at least three light sources are linear light sources.

6. The liquid crystal display of claim 5, wherein extension axes of the V-cut groove structures on the light emitting surface are perpendicular to the light sources, and extension axes of the V-cut groove structures on the bottom surface are parallel to the light sources.

7. The liquid crystal display of claim 1, wherein when a number K of the light sources is even, K is an integer, and K≧2, then a number of the light guide plates is K/2, and the light guide plates are divided into K parts.

8. The liquid crystal display of claim 7, wherein K is equal to 4.

9. The liquid crystal display of claim 1, wherein when a number K of the light sources is odd, K is an integer, and K≧2, then a number of the light guide plates is (K+1)/2, and the light guide plates are divided into K parts.

10. The liquid crystal display of claim 9, wherein K is equal to 3.

11. A driving method for a liquid crystal display, the method comprising:
providing a liquid crystal display comprising a liquid crystal panel, at least three light sources, and at least two light guide plates, the liquid crystal panel comprising a plurality of scanning lines, each light guide plate comprising a light emitting surface and a bottom surface opposite thereto, each light guide plate being divided into at least three parts, only one light guide plate having micro-structures on the light emitting surface and the bottom surface in any part, the parts with the micro-structures of the same light guide plate being separated from each other, the liquid crystal panel being divided into at least three parts;
generating a first group of scanning signals to scan the scanning lines in a first one of the at least three parts of the liquid crystal panel;
generating a first backlight control signal to turn on a first one of the light sources, such that a first one of the at least three parts of the at least two light guide plates are all strong light parts and the other parts of the at least three parts of the at least two light guide plates are weak light parts, and the first part of the liquid crystal panel is a strong light part and the other parts of the liquid crystal panel are weak light parts;
generating a second group of scanning signals to scan the scanning lines in a second one of the at least three parts of the liquid crystal panel; and
generating a second backlight control signal to turn on a second one of the light sources, such that a second one of the at least three parts of the at least two light guide plates are all strong light parts and the other parts of the at least three parts of the at least two light guide plates are weak light parts, and the second part of the liquid crystal panel is a strong light part and the other parts of the liquid crystal panel are weak light parts.

12. The driving method of claim 11, wherein the micro-structures are V-cut groove structures.

13. The driving method of claim 12, wherein each light guide plate further comprises at least one light incident surface perpendicularly adjacent to both the light emitting surface and the bottom surface, and each light source is disposed adjacent to one of the light incident surfaces of the at least two light guide plates.

14. The driving method of claim 13, wherein when a number K of the light sources is even, K is an integer, and K≧2, then a number of the light guide plates is K/2, and the light guide plates are divided into K parts.

15. The driving method of claim 14, wherein K is equal to 4.

16. The driving method of claim 13, wherein when a number K of the light sources is odd, K is an integer, and K≧2, then a number of the light guide plates is (K+1)/2, and the light guide plates are divided into K parts.

17. The driving method of claim 16, wherein K is equal to 3.
